(19) United States
(12) Patent Application Publication
(10) Pub. No.: US 2005/0253665 A1
(43) Pub. Date: Nov. 17, 2005

(54) Automatic radio frequency signal controller device and associated method

(76) Inventors: Frank Anthony Vassallo II, Tamarac, FL (US); Bruce Bennett, Ft. Lauderdale, FL (US); Florenio Pinili Regala, Costa Mesa, CA (US); Stefan Doll, Munchen (DE); Stephen R. Hershman, Pembroke Pines, FL (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/843,674

(22) Filed: May 11, 2004

(51) Int. Cl. H01P 1/10

(52) U.S. Cl. 333/101

(57) ABSTRACT

A signal controller device with an input, at least two outputs, a coupling unit for detecting a frequency of a signal arriving on the input and generating a detection signal. The device further includes a processor for receiving the detection signal from the coupling unit, calculating an electrical pathway based on the value of the detection signal, and generating a routing signal. The device has a plurality of electrical switches arranged in a path of electrical communication with the input and the at least two outputs of the controller device, and is capable of configuring the electrical pathway in response to the routing signal. The disclosure also includes a method of doing the same.

### BACKGROUND OF THE INVENTION

1. Field of the Invention

This invention relates in general to RF signal transmission and more particularly, to a device for automatically selecting and creating low-loss RF signal paths.

2. Description of the Related Art

In a multi-band communication system operating throughout the VHF and UHF frequencies (30-1000 MHz), transceivers are able to communicate over multiple frequency bands at various distances by using line-of-sight or beyond line-of-sight RF signal propagation modes. Each mode can have differing power levels and signaling requirements. In line-of-sight mode, transceivers can communicate using low power signals similar to cellular communications and AM/FM radio as long as the transceivers are within line-of-sight distance of each other, roughly 60 miles depending on antenna height. When communicating beyond the line-of-sight to transceivers over 60 miles away, generally ground wave or satellite communications are used requiring very high RF power levels to complete a communication link. In systems operating across multiple frequency bands, proper component matching and signal filtering (isolation) are needed to assure efficient voice and data throughput within the communication system.

To maximize efficiency (reduce RF signal losses) throughout a multi-band communication system, frequency-band specific circuits are typically designed into the path of the transmitted RF signal in order to properly match the RF signal's complex impedances. Complex RF signal impedances must be matched across the operating frequency bands to reduce insertion loss and maintain an efficient system over every frequency of operation. Designs using power splitters, transistor switching, active filtering, matching networks, and diplexing allow for multiple RF signals to share the same components and antennas directly in the RF path, but compensating circuits must also be included in the RF signal path to make up for losses due to these components. These approaches lead to a relatively large number of impedance matching circuits in the RF signal path unnecessarily increasing signal power loss, system complexity, and cost.

Prior art design approaches are limited in application and frequency and cannot work over very large bandwidths for a number of reasons. First some solutions incorporate complex signal path routing, matching and amplification inside low powered semiconductor-based ICs. Secondly, when routing the RF signal through multiple active and passive components, the RF signal's complex impedances vary dramatically from one frequency to the next creating insertion losses and impedance mismatches between the RF signal and components inline with the RF. These losses may cause large mismatches in the Voltage Standing Wave Ratio (VSWR), which degrade RF signal performance and can add unwanted heat in the system. Thirdly, sharing active and passive matching and amplification circuitry with the RF signal path can lead to poor isolation between frequency bands because of the large differences in filtering circuitry required within the multi-band system. Signaling and filter designs are dependant on frequency wavelength and a number of impedance matching circuits are needed to effectively tune the signal path over the entire bandwidth, adding to cost and complexity.

Impedance matching, amplification, and filtering networks are relatively easy to design into a multi-band system as long as the wavelengths within the systems are small, (i.e., the frequency is relatively high) and close to each other as in PCS, GSM and GPS systems in the 800-1900 MHz frequency range. The same design approach used in 800-1900 MHz systems are often not practical and are difficult to implement in a communications system operating throughout the 30-1000 MHz range. This is due to the extreme difference in frequency wavelength and impedance characteristics of radio frequency waves at low frequencies. More exactly, prior art solutions designed into multi-band systems operating close to 1000 MHz will not work for multi-band systems operating close to 30 MHz.

Irons (U.S. Pat. No. 4,165,497) discloses an N×M wideband switching matrix constructed from modules, which are interconnected by a simple series path. Each matrix contains a plurality of input connectors and output connectors that create an RF signal path via a directional coupler. The RF signals will incur a loss of 3 dB when passing through a power divider that leads to the directional coupler. Power dividing devices are always frequency limited, reducing this application to a narrow band of frequencies. Additionally, this RF switching matrix is not “controllable” for particular frequencies, and signal output matching are necessary at each output port. The inventor claims that the intent of this invention is to provide a switching matrix in which package is simplified by the elimination of complicated cross-connections, not to control the RF signal paths in a communication system.

Freeston et al. (U.S. Pat. Pub. No. 20020063475) discloses a device for RF signal switching in a matrix configuration embedded within an Integrated Circuit. At the heart of this invention are a number of switching Single Throw N Pole (STNP) switches, a control unit and a matching/amplification network that will compensate for the losses incurred when the RF signals are routed through the design. Because of the matching/amplification network embedded in the IC, Freeston notes high isolation and low insertion loss, but this is only attainable because of the compensating network. This invention is not applicable to RF signal controlling in a multi-band communication systems because of the high RF power requirements needed in various modes of communication and the inability to immediately provide impedance matching over wide bandwidths at frequencies covering the VHF/UHF communication spectrum.

Clifton (U.S. Patent Pub. No. 20030001787) discloses an antenna switch, and a method of providing an RF signal to an antenna switch. Clifton's design uses small signal transistors and is clearly limited in function for a number of reasons. First, he details the use of a frequency matching circuit in the RF signal path for impedance matching limiting the device and method for a particular antenna and narrow frequency band of operation. Second, transistors are used in the RF signal path to accomplish signal switching. These transistors also serve as small signal amplifiers, limiting the use in high power RF applications. Lastly, Clifton limits the operation of the antenna switch to the GSM 900 and GSM 1800 frequency bands.

Sutton et al. (U.S. Pat. Pub. No. 20020142796) discloses an antenna switch assembly. The antenna switch is embodied as an active device MMIC, and uses a number of supporting active devices directly in line with the signal path. Sutton also claims that a transmit transistor is arranged to provide amplification to the RF signal, to compensate for losses associated with the above-mentioned switching unit. Notably, the device operates only within two frequency bands, 800 and 1900 MHz. The control unit can only be used for distinguishing between these two frequencies. Lastly, a matching circuit is claimed to provide impedance matching between the signal path and the antenna connection limiting this devices operation to these particular frequency bands.

In all prior art devices, RF signal losses are incurred because the active and passive components are in the RF signal path, and designs for low frequency, high power impedance matching, amplification and filtering circuitry are not practical throughout a VHF/UHF multi-band communication system. Additionally, solutions using semiconductors (Silicon, Germanium, Gallium etc.) for signal switching are not practical in high power RF applications. In conclusion, insofar as I am aware, there has not been a device or method developed that automatically detects, identifies, and controls an RF signal path in any multi-band communication system, maintaining low RF system losses under various power condition.

Accordingly, a need exists for a device that will automatically determine the frequency band of an input signal and route the input signal to a low-loss port that will serve as the transmit/receive path until a new frequency is detected.

### SUMMARY OF THE INVENTION

The present invention concerns a software-based Automatic Radio Frequency (RF) Signal Controller device that works in conjunction with a multi-band transceiver to establish a number of frequency-dependent low-loss RF signal paths. At the time of transmission, the Automatic RF Signal Controller determines the operating frequencies of the input signal and establishes a low-loss RF signal path to one of a number of frequency-band-specific ports. These ports remain active for transmission and reception until the device detects a new frequency. The device and method detail an advancement in the art, enabling multi-band communication systems the flexibility to operate over extremely wide bandwidths and power levels without the need for impedance matching networks, or associated active and passive components, increasing communication efficiency by reducing the RF signal losses directly in RF signal path and reducing the complexity and cost of a multi-band communication system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating the inventive automatic RF signal controller;

FIG. 2a is a schematic circuit diagram of the inventive automatic RF signal controller;

FIG. 2b is a chart showing exemplary relay combinations;

FIG. 3 is a diagram of the coupling unit;

FIG. 4 is a diagram showing the method steps for selecting and creating low-loss signal paths based on an input frequency.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

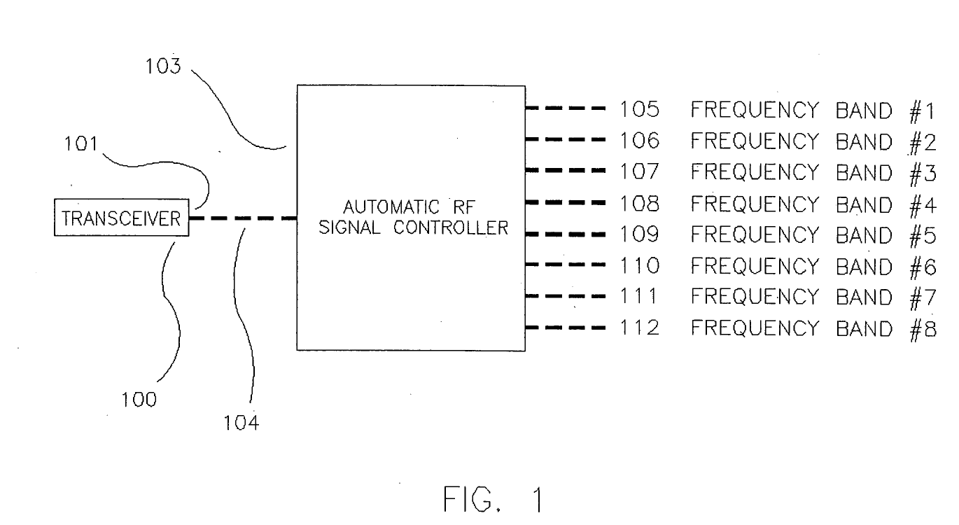

FIG. 1 shows a block diagram of the inventive Automatic RF Signal controller. The output 101 of a multi-band transceiver 100 is connected to the input port 102 of the Automatic RF Signal controller 103 by an RF connector. Each output 105-112 is assigned to a different frequency band. The controller 103 selects a transmission path and outputs the signal on one of the multiple outputs 105-112 based on the frequency band of the signal received at the input 102 of the controller 103. For exemplary purposes, eight outputs are shown in FIG. 1. This number however is not restricted to eight and could be more or less without departing from the spirit and function of the invention.

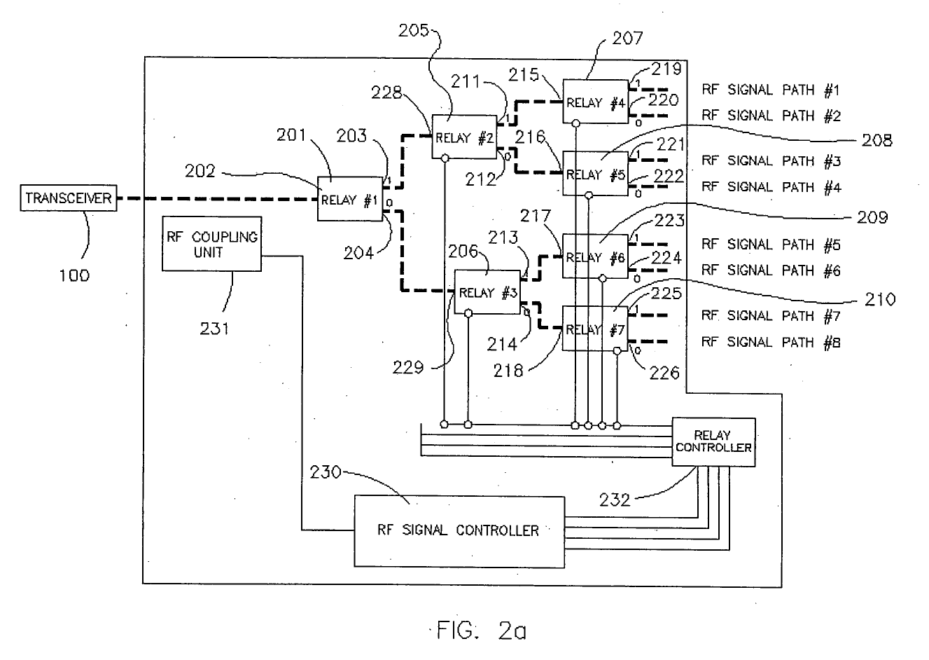

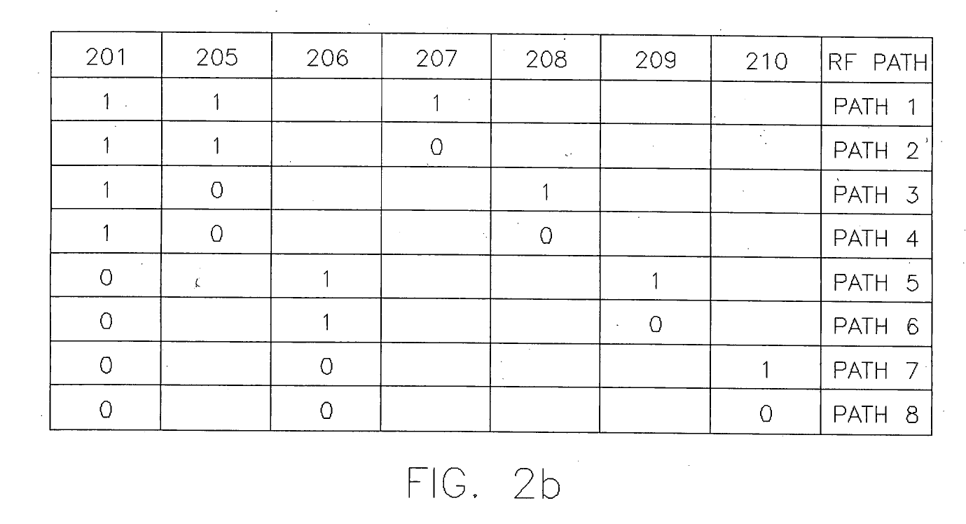

Referring now to FIG. 2a, the signal path beginning at the input port 102 of the Automatic RF Signal controller 103 is shown connected to a first switch 201. In a prefered embodiment, the switch 201 is an RF relay. RF relays are readily available in commercial markets, have low-loss characteristics in nature and consist of one input port 202 and two output ports, 203 and 204. The outputs 203, 204 of the RF relay 201 are toggled when an outside voltage or data signal is applied externally 227 to the RF relay 201. When this RF relay 201 is engaged, the inputted RF signal can be switched from output port 203 to output port 204, creating two distinct RF signal paths. The signal output from the output ports 203 or 204 can be input to a second level of RF relays 205, 206 to provide a greater number of signal pathway choices. Similarly, one of a third level of RF relays 207, 208, 209, and 210 can be connected to one of the output ports 211, 212, 213, 214 of the second level of relays 205, 206. As shown in FIG. 2a, output 211 of second level relay 205 is connected to an input 215 of third level relay 207; output 212 of second level relay 205 is connected to an input 216 of third level relay 208; output 213 of second level relay 206 is connected to an input 217 of third level relay 209; and output 214 of second level relay 206 is connected to an input 218 of third level relay 210. Each third level relay 207, 208, 209, and 210 has two outputs, 219 & 220, 221 & 222, 223 & 224, and 225 & 226, respectively. This arrangement yields a total of eight (8) distinct RF signal paths. Path 1 includes input 202 to output 203 to input 228 to output 211 to input 215 to output 219; Path 2 includes input 202 to output 203 to input 228 to output 211 to input 215 to output 220; Path 3 includes input 202 to output 203 to input 228 to output 212 to input 216 to output 221; Path 4 includes input 202 to output 203 to input 228 to output 212 to input 216 to output 222; Path 5 includes input 202 to output 204 to input 229 to output 213 to input 217 to output 223; Path 6 includes input 202 to output 204 to input 229 to output 213 to input 217 to output 224; Path 7 includes input 202 to output 204 to input 229 to output 214 to input 218 to output 225; and Path 8 includes input 202 to output 204 to input 229 to output 214 to input 218 to output 226. These paths are summarized in the matrix of FIG. 2b, where the relays are identified in the top row, the proper output for each relay is identified below in the column, and the path created is shown on the right-hand side of the matrix. The present invention, of course, is not limited to the number and arrangement of relays shown in the drawings. A greater or fewer number of relays can be used to provide a greater or fewer number of electrical pathways.

In order to properly route the RF signal to its final output port, a control processor 230 must determine at what frequency the transceiver 100 is operating. This is accomplished by sampling the transmitted RF signal, determining what frequency is in operation, and engaging the appropriate RF relay matrix to allow the RF signal flow to that output port. In order to sample the RF signal without creating RF signal mismatch (loss) or high VSWR, an inductive directional coupler 231 is used. Directional couplers are well known in the art, and operate without being in physical contact with the conductor carrying the RF input signal.

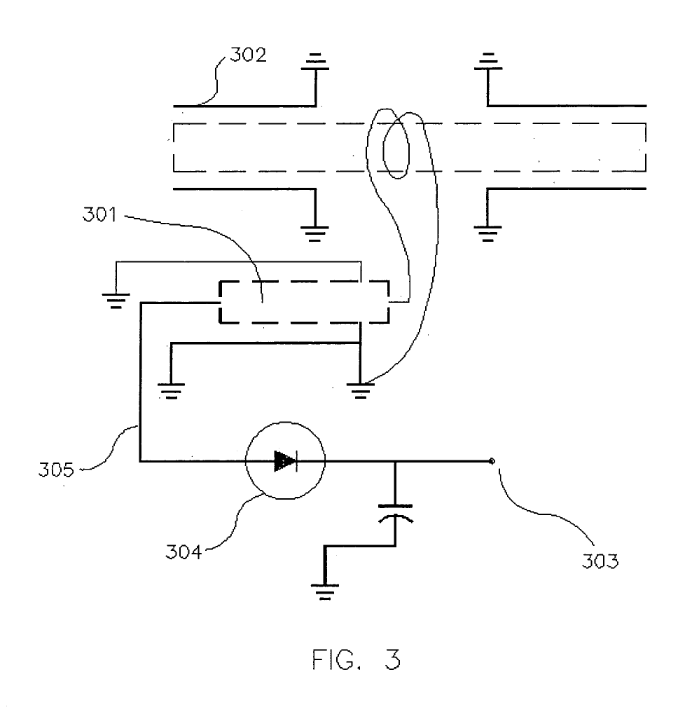

Referring now to FIG. 3, where the directional coupler 231 is shown in detail, a piece of coaxial cable 301 is placed in close proximity to the coaxial cable 302 carrying the transceiver's 100 output RF signal. Because the coaxial cable 301 is so close to the transmitting cable 302, a signal is induced in the adjacent coaxial cable 301, identical to the original signal but out of phase and at an extremely low voltage level. The principles of inductance are well know by those having ordinary skill in the art and will, therefore, not be discussed in detail.

The sampled low voltage RF signal is then carried along the center conductor 305 of coaxial cable 301, through diode 304 to an output 303 of the coupler 231 into a micro-controller 230. Diode 304 allows current in only one direction and therefore, adds the directional characteristic to the coupler 231, preventing the coupler from affecting the input signal. The microprocessor identifies the operating frequency of the signal and compares this signal against a database of possible RF path solutions programmed via software into the microprocessor. The microprocessor unit 230 outputs a voltage signal and/or binary digits that are interpreted by a relay control unit 232. The relay control unit 232 then sets the state of the state of each relay 201, 205, 206, 207, 208, 209, and 210 in accordance with the software instructions.

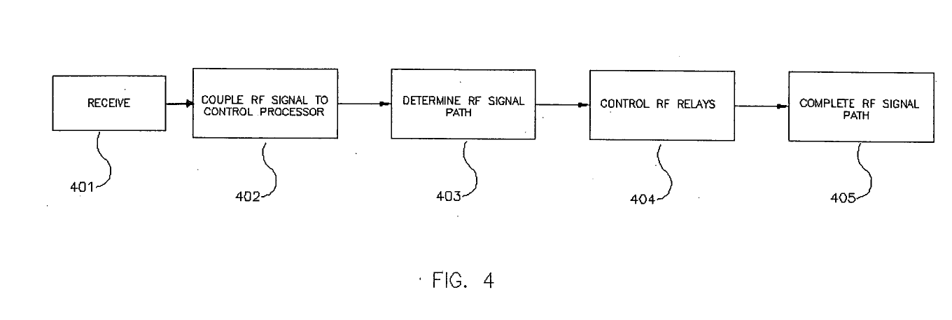

FIG. 4 shows the method steps for automatically creating an RF signal path to an output port for the purpose of establishing a low-loss transmit and receive path within a broadband communications system. In step 401, the RF signal is received. In step 402, the RF input signal is coupled to the control processor 230. The control processor 230 determines an RF signal path in step 403. Finally, in step 404, the relays 201, 205, 206, 207, 208, 209, and 210 are placed into one of two possible states by relay controller 232, thereby creating one of a several possible signal paths 405.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A signal controller device comprising:
an input;
at least two outputs;
a coupling unit for detecting a frequency of a signal arriving on the input and generating a detection signal;
a processor for receiving the detection signal from the coupling unit, calculating an electrical pathway based on the value of the detection signal, and generating a routing signal;
a plurality of electrical switches arranged in a path of electrical communication with the input and the at least two outputs of the controller device, and capable of configuring the electrical pathway in response to the routing signal.

2. The signal controller device according to claim 1, wherein the electrical switches are relays.

3. The signal controller device according to claim 2, wherein the relays are activated by a relay controller.

4. The signal controller device according to claim 3, wherein the routing signal from the processor causes the relay controller to place the relays in one of two states.

5. The signal controller device according to claim 1, further comprising the processor being pre-programmed with a database of possible electrical pathways corresponding to the value of the detection signal.

6. The signal controller device according to claim 1, wherein the frequency of the input signal is between 30 MHz and 1 GHz.

7. The signal controller device according to claim 1, wherein the frequency of the input signal is between 30 MHz and 1.9 GHz.

8. The signal controller device according to claim 1, further comprising a relay controller arranged between the processor and the switches.

9. The signal controller device according to claim 1, further comprising the plurality of switches being arranged in a parallel configuration with respect to the input and output.

10. The signal controller device according to claim 1, further comprising the plurality of switches being arranged in a series configuration with respect to the input and output.

11. The signal controller device according to claim 1, further comprising the plurality of switches being arranged so that at least two of the switches are in a series configuration and at least two of the switches are in a parallel configuration with respect to the input and output.

12. The signal controller device according to claim 1, wherein the coupling unit detects the frequency of the signal arriving on the input through inductive coupling.

13. A method for selecting a signal path comprising:
receiving an input signal;
sampling the input signal;
determining a frequency of the input signal; and
controlling at least one switch in an electrical path between an input and at least two outputs so that the input is connected to one of the outputs, based upon the frequency of the input signal.

14. The method according to claim 13, wherein an RF coupler is used for inductively sampling the input signal.

15. The method according to claim 13, wherein a microprocessor determines the frequency of the input signal.

16. The method according to claim 13, further comprising the switch being a relay.
